(19) United States
(12) Patent Application Publication
(10) Pub. No.: US 2006/0083151 A1
(43) Pub. Date: Apr. 20, 2006

(54) Optical disk and production method therefor

(76) Inventors: Toshiro Kinoshita, Tokyo (JP); Akihiko Kobayashi, Tokyo (JP); Noboru Sasaki, Tokyo (JP); Makoto Arisawa, Tokyo (JP); Mamoru Sekiguchi, Tokyo (JP); Hiroshi Hiroshi, Yokohama-shi (JP); Yoshimori Yamasaki, Kawasaki-shi (JP); Kiyoshi Osato, Chiba-shi (JP); Tamotsu Yamagami, Kawasaki-shi (JP); Hidetoshi Watanabe, Kashiwa-shi (JP)

Correspondence Address: STAAS & HALSEY LLP, SUITE 700, 1201 NEW YORK AVENUE, N.W., WASHINGTON, DC, 20005, US

(21) Appl. No.: 10/540,771

(22) PCT Filed: Jan. 30, 2004
(86) PCT No.: PCT/JP04/00908

§ 371 Date: Jun. 24, 2005

(30) Foreign Application Priority Data
Jan. 30, 2003 (JP) 2003-22308
Nov. 17, 2003 (JP) 2003-386540

(51) Int. Cl. G11B 7/00

(52) U.S. Cl. 369/125

(57) ABSTRACT

An optical disk (10) of the present invention comprises a substrate (11) included a biodegradable resin or polyolefin resin, a recording layer (13) provided on at least one side of the substrate (11), and a printing layer (15) provided on the other side of substrate (11), wherein recording layer (13) and printing layer (15) have a base material layer (recording layer base material, printing base material (21)) included a non-hydrophilic film. This type of optical disk (10) has performance equal to that of conventional optical disks, has a minimal effect on the environment during disposal and is able to suppress warping of the substrate. In addition, a manufacturing method of an optical disk of the present invention comprises a recording layer sheet fabrication step in which a recording layer sheet is fabricated by forming tracks on a recording layer base material, a printing sheet fabrication step in which a printing sheet is fabricated by carrying out printing on a printing base material, and respective lamination steps in which the substrate sheet, recording layer sheet and printing sheet are laminated.

### TECHNICAL FIELD

The present invention relates to an optical disk such as a Blu-ray disk (BD) or digital versatile disk (DVD) and manufacturing method of the same.

### BACKGROUND ART

Polycarbonate, epoxy resin and so forth have frequently been used as the substrate materials of conventional optical disks since these substrate materials are required to have low contents of extraneous materials and impurities, high permeability and low double refractive index to enable stable reading and writing, a low moisture absorption rate and superior heat resistance to prevent deformation of the optical disk, as well as high fluidity and superior mold release to facilitate molding processing (Japanese Unexamined Patent Application, First Publication No. 05-258349).

However, since bisphenol A is used as monomer for the aforementioned polycarbonate and epoxy resin substrate materials, unreacted bisphenol A remained even after polymerization. Due to the growing interest in environmental issues in recent years, materials containing bisphenol A have tended to be shunned, and studies have been conducted on substrate materials that do not contain bisphenol A.

The use of glass has been considered for use as a substrate material since it does not contain bisphenol A and satisfactory optical characteristics in the form of high transmittance. However, glass substrates have problems in terms of strength in that they are unable to accommodate the pressure and stress during production and use due to limitations on disk thickness.

An optical disk in which an optical recording layer is formed on a substrate surface composed of a biodegradable resin is proposed in Japanese Unexamined Patent Application, First Publication No. 2000-11448 as an optical disk that has a minimal effect on the environment at the time of disposal. However, in the production of this optical disk since surface irregularities in the form of pits are stamped directly onto the surface of a disk-shaped substrate that has been punched out from an extruded sheet (refer to paragraphs 0018 through 0019), there is the problem of difficulty in stamping the pits. In addition, there is also the problem of increased susceptibility to warping of the substrate due to moisture absorption resulting in impaired reading of information.

Another problem with conventional optical disks is that, although silk screen printing has mainly been used in the case of printing characters or images on the surface, there is the problem of the difficulty in obtaining highly detailed images with silk screen printing.

In addition, in the case of silk screen printing, in order to print serial numbers or other different characters and images for each disk, it is necessary to change the form plate each time, thereby resulting in the problem of being unable to in fact impart variable information by printing to conventional optical disks.

Accordingly, an object of the present invention is to provide an optical disk that has performance equal to that of conventional optical disks, has a minimal effect on the environment during disposal and is able to suppress warping of the substrate, as well as a manufacturing method that allows this optical disk to be obtained easily and inexpensively.

In addition, another object of the present invention is to provide an optical disk on which highly detailed images are printed, and manufacturing method of an optical disk that enables highly detailed images to be printed inexpensively and impart variable information by printing.

### DISCLOSURE OF THE INVENTION

An optical disk of the present invention has a substrate included a biodegradable resin or polyolefin resin and a recording layer provided on both sides of the substrate, and the recording layer has a base material layer included a non-hydrophilic film.

In addition, an optical disk of the present invention has a substrate included a biodegradable resin or polyolefin resin, a recording layer provided on one side of the substrate, and a printing layer provided on the opposite side of the side of the substrate on which the recording layer is provided, and the recording layer and the printing layer have a base material layer included a non-hydrophilic film.

Since this type of optical disk uses a substrate included biodegradable resin or polyolefin resin for the substrate, it has a minimal effect on the environment during disposal while retaining performance that is equal to that of optical disks of the prior art. In addition, since a recording layer is provided on both sides of the substrate or a recording layer is provided on one side of the substrate while a printing layer is provided on the other side of the substrate, and the recording layer and printing layer have a base material layer included a non-hydrophilic film, water absorption and moisture absorption of the substrate can be suppressed, thereby making it possible to suppress warping and other deformation of the optical disk.

In addition, if the substrate additionally has a protective layer that protects the aforementioned recording layer, then together with preventing scratching of the recording layer, water absorption and moisture absorption of the substrate can be further suppressed, and warping and other deformation of the optical disk can be further suppressed.

In addition, if a release layer is provided between the substrate and the recording layer and/or printing layer, since the substrate and recording layer and/or printing layer can be separated and disposed of separately at the time of disposal, each layer can be disposed of in accordance with the material of which it is made, thereby making it possible to further reduce the effect on the environment.

In addition, manufacturing method of an optical disk of the present invention has a recording layer sheet fabrication step in which a recording layer sheet is fabricated by forming tracks on a recording layer base material included a non-hydrophilic film; and, a recording layer sheet lamination step in which a recording layer included the recording layer sheet is provided on both sides of a substrate included a biodegradable resin or polyolefin resin by laminating the recording layer sheet with a substrate sheet included a biodegradable resin or polyolefin resin.

In addition, manufacturing method of an optical disk of the present invention has a recording layer sheet fabrication step in which a recording layer sheet is fabricated by forming tracks on a recording layer base material included a non-hydrophilic film, a printing sheet fabrication step in which a printing sheet is fabricated by carrying out printing on a printing base material included a non-hydrophilic film, a recording layer sheet lamination step in which a recording layer included the recording layer sheet is provided on a substrate included a biodegradable resin or polyolefin resin by laminating the recording layer sheet with a substrate sheet included a biodegradable resin or polyolefin resin, and a printing sheet lamination step in which a printing layer included the printing sheet is provided on a substrate included a biodegradable resin or polyolefin resin by laminating the printing sheet with a substrate sheet included a biodegradable resin or polyolefin resin.

In addition, manufacturing method of an optical disk of the present invention also preferably has a protective film lamination step in which a protective layer included a protective film is provided on the recording layer by laminating the protective film onto the recording layer.

In addition, manufacturing method of an optical disk of the present invention also preferably has a release layer formation step in which a release layer is formed on at least one side of the substrate sheet in advance.

In addition, manufacturing method of an optical disk of the present invention preferably produces each sheet in the form of a wound roll and then laminates each of these sheets in the form of wound rolls.

In this type of the manufacturing method of an optical disk, since the substrate, recording layer and as necessary, printing layer and protective layer, are formed by prefabricating their corresponding sheets in advance followed by their lamination, an optical disk having little substrate warping can be produced easily and inexpensively.

In addition, since the manufacturing method has fabricating a printing sheet by carrying out printing on a printing base material in advance followed by laminating it to the substrate, highly detailed images can be obtained easily and inexpensively. In addition, variable information, such as sequentially changing serial numbers, that differs for each disk can be imparted by printing onto the optical disk.

### BRIEF DESCRIPTION OF THE DRAWINGS

FIG. 1 is a schematic cross-sectional view showing an example of an optical disk of the present invention.

FIG. 2 is a schematic cross-sectional view showing an example of a recording layer in a playback-only optical disk.

FIG. 3 is a schematic cross-sectional view showing an example of a recording layer in a write-once optical disk.

FIG. 4 is a schematic cross-sectional view showing an example of a recording layer in a rewritable optical disk.

FIG. 5 is a schematic cross-sectional view showing another example of an optical disk of the present invention.

FIG. 6 is a schematic drawing showing a printing sheet and a recording sheet.

FIG. 7 is a schematic drawing showing (a) a printing sheet fabrication step, (b) a substrate sheet fabrication step, and (c) a recording layer sheet fabrication step.

FIG. 8 is a schematic drawing showing the lamination steps for each sheet.

### BEST MODE FOR CARRYING OUT THE INVENTION

An optical disk of the present invention is that having a substrate composed of a biodegradable resin or polyolefin resin and a recording layer provided on both sides of the substrate, or that having a substrate composed of a biodegradable resin or polyolefin resin, a recording layer provided on one side of the substrate, and a printing layer provided on the opposite side from the side of the substrate on which the recording layer is provided, and also has a release layer between the substrate and recording layer as necessary.

Specific examples of the layer composition of an optical disk of the present invention include: (1) recording layer/substrate/printing layer, (2) recording layer/substrate/recording layer, (3) protective layer/recording layer/substrate/printing layer, (4) protective layer/recording layer/substrate/recording layer/protective layer, (5) protective layer/recording layer/release layer/substrate/printing layer, (6) protective layer/recording layer/release layer/substrate/release layer/printing layer, and (7) protective layer/recording layer/release layer/substrate/release layer/recording layer/protective layer. Here, a pressure-sensitive adhesive layer for laminating each layer may be provided between each layer as necessary.

The following provides an explanation of an optical disk having the layer composition of (3) above with reference to the drawings.

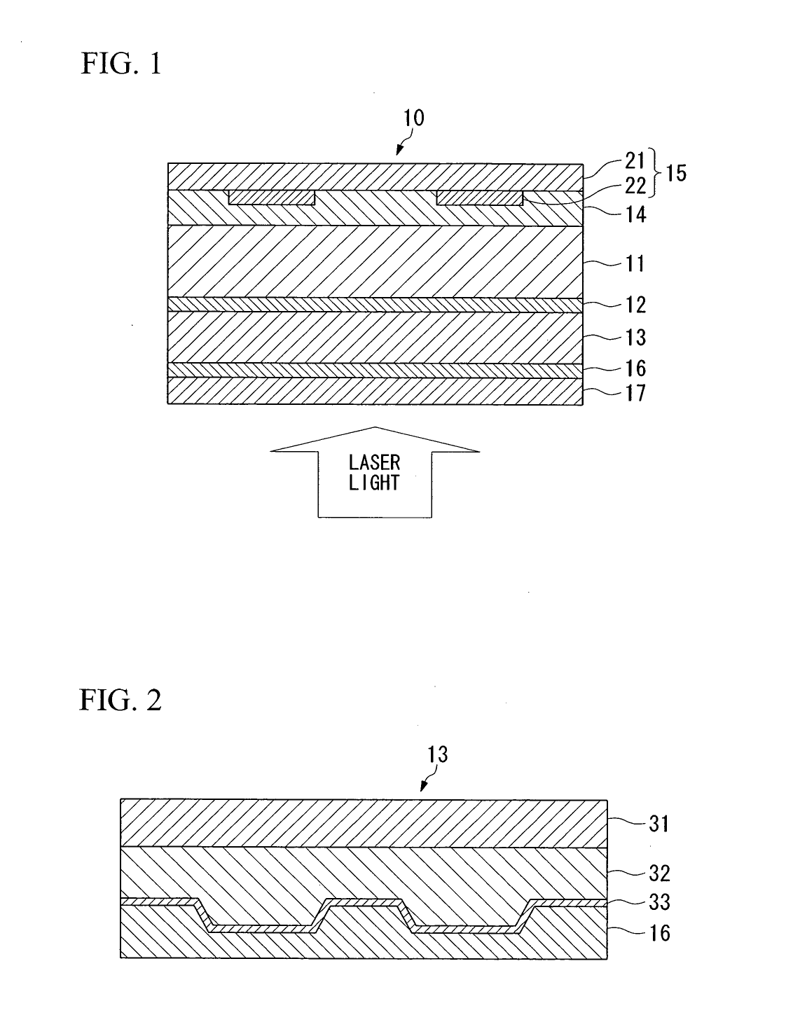

FIG. 1 is schematic cross-sectional view showing an example of an optical disk of the present invention. This optical disk 10 is roughly composed having a substrate 11 composed of a biodegradable resin or polyolefin resin, a recording layer 13 laminated on one side of substrate 11 with a pressure-sensitive adhesive layer 12 interposed between, a printing layer 15 laminated on the other side of substrate 11 with a pressure-sensitive adhesive layer 14 interposed between, and a protective layer 17 laminated on recording layer 13 with a pressure-sensitive adhesive layer 16 interposed between.

<Substrate>

Substrate 11 retains strength required for use as an optical disk, and is required to have rigidity, moisture resistance and water resistance. It is also required to have a minimal effect on the environment during disposal. Consequently, in the present invention, a substrate composed of a biodegradable resin or polyolefin resin is used for the substrate. A biodegradable resin has a minimal effect on the environment since it is decomposed by microbes in the soil and so forth even if disposed of as is. In addition, a polyolefin resin has a minimal effect on the environment since it can be disposed of by incineration and so forth and is broken down into water and carbon dioxide as a result of incineration.

Polylactic acid resin, for example, can be used as a biodegradable resin. Polylactic acid resin, for example, can be used as a biodegradable resin. Examples of polylactic acid resins include “Ecoloju” manufactured by Mitsubishi Plastics Inc., “Terramac” manufactured by Unitika, Ltd., and “Palgreen LC” manufactured by Tohcello Co., Ltd. In addition, copolymer polyesters of polyvalent alcohols such as 1,4-butadiol and pentaerythritol, and succinic acid or adipic acid, for example, can also be used as biodegradable resins. Examples of this type of biodegradable polyester resins include “Biomax” manufactured by DuPont and “Bionolle” manufactured by Showa High Polymer Co., Ltd.

Preferable examples of polyolefin resins include low density polyethylene (LDPE), linear low density polyethylene (LLDPE), high density polyethylene (HDPE), polypropylene, non-crystalline cyclic polyolefins, tetracyclododecene polymers and cycloolefin polymers. HDPE, polypropylene, non-crystalline cyclic polyolefins, tetracyclododecene polymers and cycloolefin polymers are particularly preferable with respect to rigidity.

In addition, a drawn film (drawn sheet), in which a film composed of a biodegradable resin or polyolefin resin is drawn, is preferable for substrate 11 with respect to mechanical strength and transparency.

The thickness of substrate 11 is preferably 0.5 to 2.0 mm in consideration of optical disk strength and optical disk specifications.

<Recording Layer>

Recording layer 13 is a layer on which information is recorded and/or a layer on which information can be recorded, and is able to record and/or read information by being irradiated with light.

Recording layer 13 includes that on which information has been recorded in advance at the time of optical disk production, and that on which information can be recorded after production, and is normally classified into one of three types consisting of: (1) that on which information is recorded in advance at the time of optical disk production but on which information cannot be recorded after production (playback-only type); (2) that on which information is not recorded at the time of optical disk production but on which information can be recorded after production (write-once type); and, (3) that from which recorded information can be erased and on which information can be re-recorded (rewritable type).

The following provides a detailed explanation of each type of recording layer.

(Playback-Only Type)

FIG. 2 is a cross-sectional view showing an example of a playback-only type of recording layer. This recording layer 13 is roughly composed having a recording layer base material 31 (base material layer), an information pit forming layer 32 having irregularities in its surface formed on the surface of recording layer base material 31, and a light reflecting layer 33 that covers the surface irregularities of information pit forming layer 32, and the side having recording layer base material 31 contacts a pressure-sensitive adhesive layer 12 (not shown), while the side having light reflecting layer 33 contacts a pressure-sensitive adhesive layer 16.

Recording layer base material 31 serves as a support of recording layer 13. A non-hydrophilic film is used for recording layer base material 31 in consideration of suppressing water absorption and moisture absorption by substrate 11. There are no particular limitations on the non-hydrophilic film provided it is a film composed of a resin that does not contain bisphenol A.

Preferable examples of a non-hydrophilic film in particular include polyolefin films composed of low density polyethylene (LDPE), linear low density polyethylene (LLDPE), high density polyethylene (HDPE), polypropylene, non-crystalline cyclic polyolefins, tetracyclododecene polymers or cycloolefin polymers in consideration of enabling disposal by incineration and minimal effects on the environment as a result of being decomposed into water and carbon dioxide by incineration.

In addition, a biodegradable resin film is preferable for the non-hydrophilic film in consideration of minimal effects on the environment as a result of being decomposed by microbes in the soil and so forth even if disposed directly. The same biodegradable resins used for the aforementioned substrate 11 can be used for the biodegradable resin.

The thickness of the non-hydrophilic film is preferably 30 μm or more in consideration of maintaining the strength of a support.

Information pit forming layer 32 has irregularities in its surface, and tracks and information pits are represented by these surface irregularities. Information pit forming layer 32 is the result of curing an ultraviolet-cured resin in which a photoinitiator is combined with an oligomer or monomer such as urethane acrylate oligomer, polyester acrylate oligomer or low-viscosity acrylic monomer; and uring an electron beam-cured resin such as urethane-denatured acrylate resin or acrylic-denatured polyester resin. However, it is preferable not to use an epoxy resin that contains bisphenol A.

The thickness of information pit forming layer 32 is normally 20 to 80 nm.

Light reflecting layer 33 is provided along the surface irregularities of information pit forming layer 32 and reflects irradiated light. Light reflecting layer 33 is a thin film composed of a metal such as aluminum, aluminum alloy, silver or silver alloy formed by, for example, vacuum deposition or sputtering.

The thickness of light reflecting layer 33 is normally 10 to 100 rum, and the thickness is preferably uniform.

(Write-Once Type)

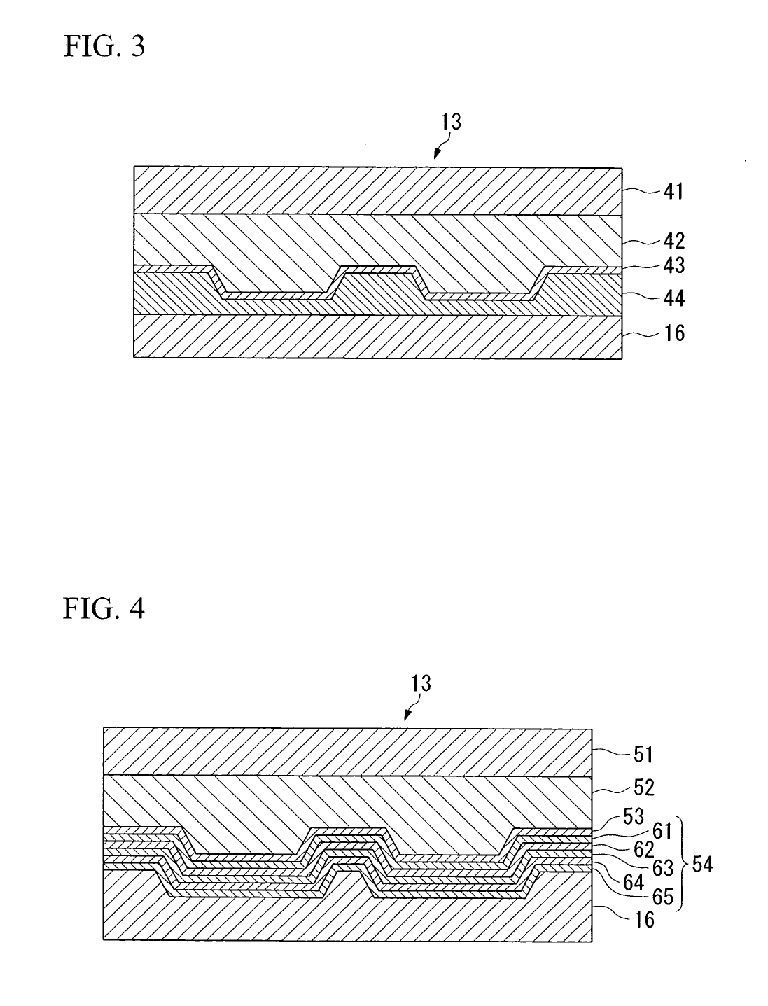

FIG. 3 is a cross-sectional view showing an example of a write-once type of recording layer. This recording layer 13 is roughly composed having a recording layer base material 41 (base material layer), an information track forming layer 42 having irregularities in its surface formed on the surface of recording layer base material 41, a light reflecting layer 43 that covers the surface irregularities of information track forming layer 42, and an information pit recording layer 44 formed on the surface of light reflecting layer 43, and the side of recording layer base material 41 contacts a pressure-sensitive adhesive layer 12 (not shown), while the side of information pit recording layer 44 contacts a pressure-sensitive adhesive layer 16.

Recording layer base material 41 serves as a support of recording layer 13. The same non-hydrophilic films as the aforementioned recording layer base material 31 can be used for recording layer base material 41.

Information track forming layer 42 has irregularities in its surface having a depth of 50 to 110 nm, and tracks are represented by these surface irregularities. However, differing from a playback-only type, information pits are not formed. An ultraviolet-cured resin or electron beam-cured resin is cured in the same manner as the aforementioned information pit forming layer 32 for information track forming layer 42.

Light reflecting layer 43 is provided along the surface irregularities of information track forming layer 42, and reflects irradiated light. Light reflecting layer 43 is a metal thin film formed by vacuum deposition or sputtering in the same manner as the aforementioned light reflecting layer 33.

Information pit recording layer 44 is a colored film composed of, for example, an organic pigment, and as a result of being irradiated with laser light for information recording, this portion becomes information pits where information signals are recorded as a result of undergoing a physical change (destruction) following the occurrence of a change in the molecular structure of organic pigment at the irradiated site. Since the site where the physical change has occurred decreases in optical transmittance, when irradiated with light for reading, the amount of reflected light from light reflecting layer 43 decreases, and as a result, information signals can be detected in the same manner as in the case of surface irregularity pits being formed.

Examples of organic pigments include phthalocyanine pigment, naphthalocyanine pigment and naphthoquinone pigment.

The thickness of information pit recording layer 44 is normally 50 to 200 nm.

(Rewritable Type)

FIG. 4 is a cross-sectional view showing an example of a rewritable type of recording layer. This recording layer 13 is roughly composed having a recording layer base material 51 (base material layer), an information track forming layer 52 having irregularities in its surface formed on the surface of recording layer base material 51, a light reflecting layer 53 that covers the surface irregularities of information track forming layer 52, and an information pit recording layer 54 formed on the surface of light reflecting layer 53, and the side of recording layer base material 51 contacts a pressure-sensitive adhesive layer 12 (not shown), while the side of information pit recording layer 54 contacts a pressure-sensitive adhesive layer 16.

Recording layer base material 51 serves as a support of recording layer 13. The same non-hydrophilic films as the aforementioned recording layer base material 31 can be used for recording layer base material 5 1.

Information track forming layer 52 has irregularities in its surface having a depth of 50 to 110 nm, and tracks are represented by these surface irregularities. However, differing from a playback-only type, information pits are not formed. An ultraviolet-cured resin or electron beam-cured resin can be cured in the same manner as the aforementioned information pit forming layer 32 for information track forming layer 52.

Light reflecting layer 53 is provided along the surface irregularities of information track forming layer 52, and reflects irradiated light. Light reflecting layer 53 is a metal thin film formed by vacuum deposition or sputtering in the same manner as the aforementioned light reflecting layer 33.

Information pit recording layer 54 is a transparent dielectric film composed of three layers consisting of, for example, an SiO₂ film, GeSbTe film and SiO₂ film, and the information pit recording layer shown in the drawing has a bilayer structure laminated in the order of SiO₂ film 61, GeSbTe film 62, SiO₂ film 63, GeSbTe film 64 and SiO₂ film 65.

The recording, erasure and reading of information by information pit recording layer 54 is carried out in the manner described below.

Laser light is focused on a GeSbTe film to heat this film followed by rapid cooling to record information by polycrystallizing or decrystallizing the GeSbTe film. Laser light that is weak enough not to affect the GeSbTe film is irradiated, the laser light penetrates the polycrystallized or decrystallized GeSbTe film, and the light reflected by the light reflecting layer is received allowing information to be read depending on whether or not there is crystallization of the GeSbTe film. On the other hand, information is erased by crystallizing the GeSbTe film as a result of focusing laser light of a lower intensity onto a polycrystallized or decrystallized GeSbTe film to slowly heat the film. This recording and erasure is reversible, and different information can again be recorded after a recording has been erased.

A ZnS—SiO₂ film, Ta₂O₅ film, SiN film or AlN film can be used instead of an SiO₂ film. In addition, an AgInSbTe film can be used instead of a GeSbTe film.

Each of these films can be formed by sputtering, vacuum deposition and so forth.

The thickness of each film is roughly 10 to 300 nm, and should be suitably set according to the type and number of layers. For example, the thickness of each film of information pit recording layer 54 is 220 nm for the SiO₂ film, 13 nm for the GeSbTe film, 25 nm for the SiO₂ film, 40 nm for the GeSbTe film and 95 nm for the SiO₂ film in that order.

<Printing Layer>

Printing layer 15 is formed by printing by printing ink 22 on printing base material 21 (base material layer). Here, although printing is carried out on the side of pressure-sensitive adhesive layer 14, namely on the back side of printing base material 21, this is preferable since in addition to being able to protect the printed surface composed of printing ink 22, unique images having both luster and depth can be obtained.

A non-hydrophilic film is used for printing base material 21 in consideration of suppressing water absorption and moisture absorption by substrate 11. There are no particular limitations on the non-hydrophilic film provided it is a film that does not contain bisphenol A.

Preferable examples of a non-hydrophilic film in particular include polyolefin films in consideration of enabling disposal by incineration and minimal effects on the environment as a result of being decomposed into water and carbon dioxide by incineration. In addition, a biodegradable resin film is preferable for the non-hydrophilic film in consideration of minimal effects on the environment as a result of being decomposed by microbes in the soil and so forth even if disposed of directly.

The same films as those used in the aforementioned recording layer base material 31 can be used for the polyolefin film and biodegradable resin film.

The thickness of printing base material 21 is normally 12 to 80 μm.

There are no particular limitations on printing ink 22 provided it does not contain bisphenol A. An example of printing ink 22 is a printing ink having a biodegradable resin such as polylactic acid resin as a binder while also containing various types of additives in consideration of minimal effects on the environment during disposal. Examples of additives include coloring pigments, pigment dispersants and viscosity adjusters.

Examples of characters and images formed by printing include markings that at least indicate the type of optical disk, additional information relating to the optical disk (such as manufacturer, retailer, price, storage capacity and usage precautions), and full-color decorative images having intermediate gradations (such as images of the recorded information). In addition, an area enabling the writing of additional information with a pencil, ballpoint pen or ink jet printer and so forth may also be provided.

<Protective Layer>

Protective layer 17 protects the surface of recording layer 13 and prevents damage to the recording layer. In addition, protective layer 17 also fulfills the role of suppressing water absorption and moisture absorption of substrate 11.

Since it is necessary for protective layer 17 to allow light irradiated onto the optical disk to penetrate to recording layer 13, it is preferably a resin film having high optical transmittance. In addition, preferable examples of resin films include polyolefin films and biodegradable resin films in consideration of minimal effects on the environment during disposal.

The same films used for the aforementioned recording layer base material 31 can be used for the polyolefin film and biodegradable resin film.

The thickness of protective layer 17 is normally 0.03 to 1.0 mm, and preferably 0.1 to 0.6 mm.

Furthermore, protective layer 17 may be composed by directly coating a liquid ultraviolet-cured resin, electron beam-cured resin, and so forth onto recording layer 13 by spin coating without using a pressure-sensitive adhesive layer 16 to be described later, followed by the curing thereof.

<Pressure-Sensitive Adhesive Layers>

Pressure-sensitive adhesive layers 12, 14 and 16 are for laminating each layer, and are layers composed of a pressure-sensitive adhesive. Acrylic pressure-sensitive adhesives and other known pressure-sensitive adhesives can be used for the pressure-sensitive adhesive.

The amount of pressure-sensitive adhesive should be suitably determined according to the material of each layer to be laminated. It is preferable that pressure-sensitive adhesive layer 12 laminated between substrate 11 and recording layer 13 have a smooth surface on the side of recording layer 13.

<Release Layers>

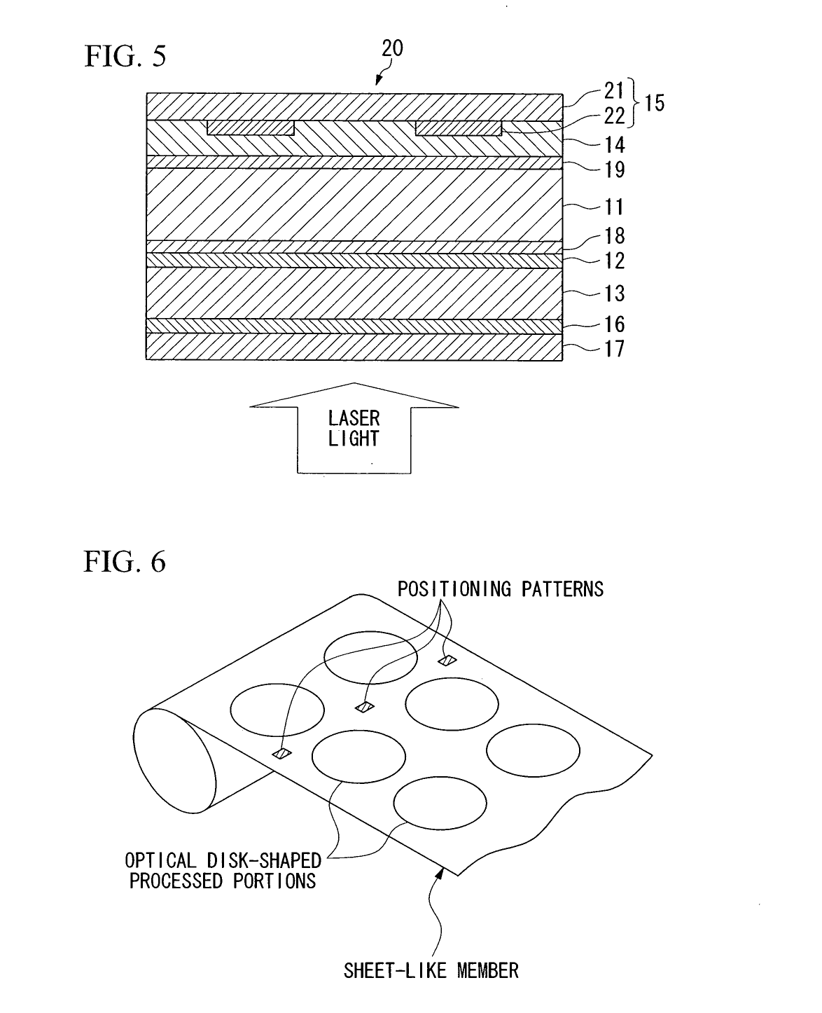

As shown in FIG. 5, an optical disk of the present invention may be an optical disk 20 in which release layers 18 and 19 are provided between substrate 11 and recording layer 13 and between substrate 11 and printing layer 15 for separation of each layer during disposal.

Release layers 18 and 19 are preferably made of materials having low levels of surface activity, examples of which include polyolefins such as polyethylene and polypropylene.

The thickness of release layers 18 and 19 is normally 5 μm to 1 mm.

<Optical Disk Production Process>

The following provides an explanation of a process for producing an optical disk of the present invention.

An optical disk production process of the present invention is a process for producing an optical disk consisting of producing a printing layer, substrate, recording layer and protective layer separately with each sheet-like member wound as shown in FIG. 6, coating pressure-sensitive adhesives in a predetermined order in the final step, and then pressing and laminating them together to obtain the desired layer composition followed by punching out into the shape of a disk.

The following provides an explanation of an example of a production process of optical disk 20 having the layer composition shown in FIG. 5.

A printing sheet is fabricated in advance by printing onto printing base material 21 (printing sheet fabrication step), release layers 18 and 19 are formed on both sides of a substrate sheet composed of a biodegradable resin or polyolefin resin (release layer formation step), and a recording layer sheet is fabricated by forming tracks on recording layer base material 31 (41 or 51) (recording layer sheet fabrication step). Next, a printing layer 15 composed of the printing sheet is provided on substrate 11 composed of a biodegradable resin or polyolefin resin by laminating the substrate sheet and the aforementioned printing sheet (printing sheet lamination step), recording layer 13 composed of the printing layer sheet is provided on substrate 11 composed of a biodegradable resin or polyolefin resin by laminating the substrate sheet and the aforementioned recording layer sheet (recording layer sheet lamination step), and protective layer 17 composed of a protective film is provided on recording layer 13 by laminating a protective film on recording layer 13 (protective film lamination step) to form an optical disk roll having the desired layer composition followed by punching out said roll into the shape of disks to produce optical disk 20.

<Printing Sheet Fabrication Step>

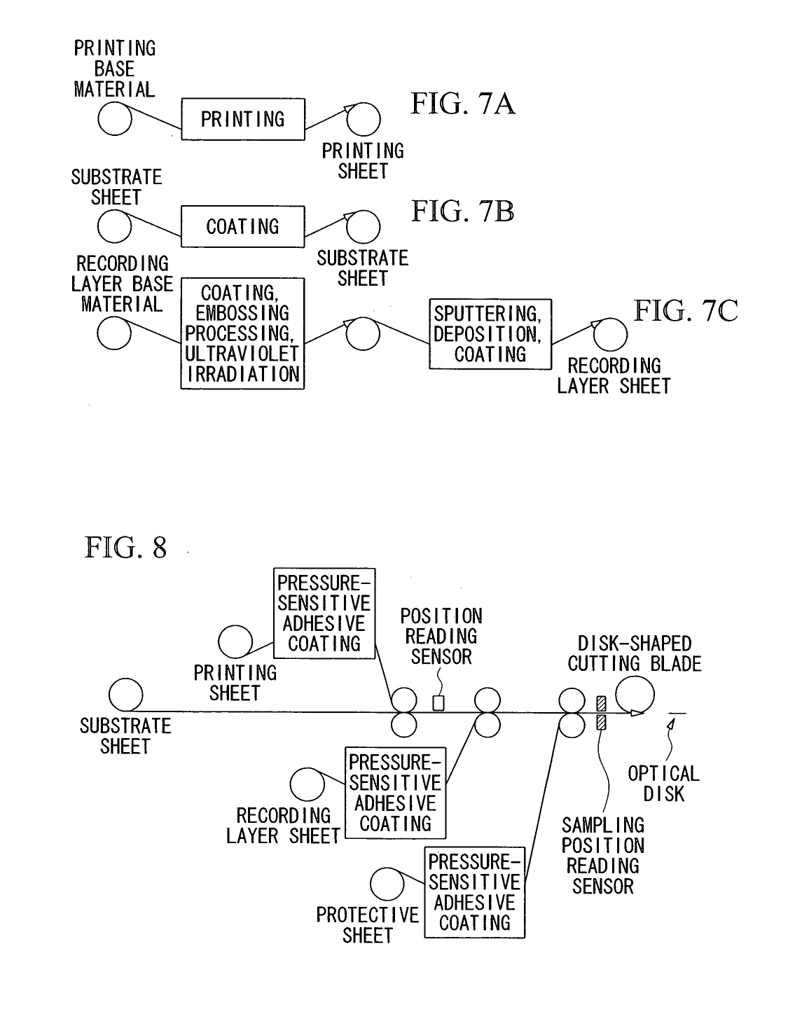

A printing sheet is fabricated by carrying out printing by printing ink 22 on printing base material 21 according to the step shown in FIG. 7A followed by winding onto a roller. At this time, positioning patterns are printed onto the printing sheet as shown in FIG. 6.

Examples of printing methods include offset printing, gravure printing, relief printing, screen printing, ink jet printing and electrophotography. Offset printing or gravure printing is particularly preferable in the case of full-color printing having intermediate gradations since these methods allow the obtaining of high-definition images. In addition, ink jet printing or electrophotography is preferable in the case of imparting variable information that differs for each disk.

<Release Layer Formation Step>

Release layers 18 and 19 are formed in advance on the substrate sheet serving as substrate 11 by molten extrusion coating of a polyolefin such as polyethylene onto both of its sides according to the step shown in FIG. 7(b). The substrate sheet on which release layers 18 and 19 are formed is wound into the shape of a roll.

<Recording Layer Sheet Fabrication Step>

A recording layer sheet is fabricated by forming tracks on recording layer base material 31 (41 or 51), forming various layers respectively corresponding to a playback-only type, write-once type or rewritable type, and winding into the shape of a roll according to the step shown in FIG. 7(c). At this time, positioning patterns (surface irregularities and so forth) are formed in the recording layer sheet as shown in FIG. 6.

(Playback-Only Type)

First, an ultraviolet-cured resin is coated onto recording layer base material 31, and a transfer mold having surface irregularities corresponding to tracks and information pits is pressed against its surface to transfer the surface irregularities to the surface of the ultraviolet-cured resin (embossing processing). Next, the ultraviolet-cured resin is cured by irradiating with ultraviolet light to form information pit forming layer 32. At this time, by using a transfer mold having a diffraction grating pattern or hologram pattern in addition to the surface irregularities corresponding to tracks and information pits for the transfer mold, an anti-theft or other pattern can also be formed on information pit forming layer 32.

Next, light reflecting layer 33 composed of a metal thin film is formed on information pit forming layer 32 by vacuum deposition or sputtering.

(Write-Once Type)

The formation of information track forming layer 42 and light reflecting layer 43 is carried out in the same manner as information pit forming layer 32 and light reflecting layer 33 of the playback-only type. However, a transfer mold that does not have surface irregularities corresponding to information pits is used for the transfer mold.

Next, an organic pigment is coated onto light reflecting layer 43 to form information pit recording layer 44 composed of an organic pigment colored film. Examples of coating methods include gravure coating, microgravure coating, die coating, comma coating, air knife coating and roll coating.

(Rewritable Type)

The formation of information track forming layer 52 and light reflecting layer 53 is carried out in the same manner as the write-once type.

Next, SiO₂ film 61, GeSbTe film 62, SiO₂ film 63, GeSbTe film 64 and SiO₂ film 65 are sequentially formed on light reflecting layer 53 by sputtering or vacuum deposition.

<Lamination Steps>

As shown in FIG. 8, a pressure-sensitive adhesive is first coated on the printed side of a printing sheet, and this is laminated with a substrate sheet.

Next, a pressure-sensitive adhesive is coated onto a recording layer sheet and this is laminated onto the other side of the substrate sheet to which the printing sheet has been laminated. At this time, the printing sheet and recording layer sheet are positioned by reading the positioning patterns on the printing sheet and the positioning patterns on the recording layer sheet with a position reading sensor and so forth.

Next, a pressure-sensitive adhesive is coated onto a protective sheet, and this is laminated onto recording layer 13 on the substrate sheet to form an optical disk roll.

<Punching Step>

Next, the optical disk-shaped processed portions of the roll are synchronized with a disk-shaped cutting blade by reading the positioning patterns with a sampling position reading sensor, and the roll is punched out in the shape of disks with the disk-shaped cutting blade to obtain optical disks.

Optical disks obtained in this manner can be deformed depending on the material of each layer. Accordingly, in order to ensure smoothness, a step may be inserted in which warping of the roll is removed by heating the optical disks from both sides with a flat heating plate.

In an optical disk of the present invention as has been explained above, since a substrate composed of a biodegradable resin or polyolefin resin is used for substrate 11, it can be disposed of easily by incineration or burying underground, and there is only a minimal effect on the environment at that time. In addition, in an optical disk of the present invention, since a substrate composed of a biodegradable resin or polyolefin resin is used for substrate 11, the optical disk has the required strength for use as an optical disk.

In addition, since printing layer 12 is additionally provided on the side of substrate 11 opposite from the side on which recording layer 13 is provided, both sides of substrate 11 are covered, thereby making it possible to suppress water absorption and moisture absorption by substrate 11, as well as suppress warping and other deformation of the optical disk.

Moreover, since recording layer 13 has a recording layer base material 31 (41 or 5 1) composed of a non-hydrophilic film, water absorption and moisture absorption by substrate 11 can be further suppressed, and warping and other deformation of the optical disk can be further suppressed.

In addition, since printing layer 15 has a printing base material 21 composed of a non-hydrophilic film, water absorption and moisture absorption by substrate 11 can be further suppressed, thereby making it possible to further suppress warping and other deformation of the optical disk.

A similar action is demonstrated even if recording layer 13 is provided on both sides of substrate 11.

In addition, since recording layer 13 additionally has a protective layer 17 that protects recording layer 13, together with preventing recording layer 13 from being damaged, water absorption and moisture absorption by substrate 11 can be further suppressed, thereby making it possible to further suppress warping and other deformation of the optical disk.

In addition, since release layers 18 and 19 are provided between substrate 11 and recording layer 13 and between substrate 11 and printing layer 15, substrate 11, recording layer 13 and printing layer 15 can be separated at the time of disposal and disposed of separately, thereby enabling disposal corresponding to the material of each layer and making it possible for further reduce the effects on the environment.

In addition, in manufacturing method of an optical disk of the present invention, since substrate 11, recording layer 13, printing layer. 15 and protective layer 17 are formed by fabricating their corresponding sheets in advance followed by laminating those sheets, differing from coating by spin coating and so forth, there is less material waste, and differing from the case of preliminarily laminating each layer that composes printing layer 13, recording layer 15 and protective layer 17 on a substrate in order, an optical disk having little warping of substrate 11 can be produced inexpensively without being subjected to stress caused by differences in the coefficients of thermal expansion.

In addition, since a method is employed in which printing is carried out in advance on printing base material 21 to fabricate a printing sheet followed by laminating this onto substrate 11, high-definition printing can be carried out, and highly detailed images can be obtained inexpensively. In addition, serial numbers and other variable information that differs for each disk can be printed onto an optical disk in the aforementioned printing sheet fabrication step.

Furthermore, an optical disk of the present invention is not limited to that described in the aforementioned embodiments, but rather the design and so forth may be altered within a range that does not deviate from the gist of the present invention.

For example, an optical disk of the present invention is not limited to a disk shape, but may be rectangular or any other arbitrary shape provided the region where information is recorded is circular.

In addition, although a pressure-sensitive adhesive is used when laminating each layer in the aforementioned embodiments, an adhesive layer, adhesive material, or a pressure-sensitive adhesive material in which a pressure-sensitive adhesive or adhesive has been formed into the shape of a sheet may also be used for the pressure-sensitive adhesive.

### EXAMPLES

The following indicates examples of the present invention.

### Example 1

(Fabrication of Printing Sheet)

Gravure printing was carried out using biodegradable polyester printing ink (Dainichiseika Color and Chemicals, Biotech Color HGP) on a polylactic acid film drawn to a thickness of 0.04 mm (Mitsubishi Plastics, Ecoloju) to obtain a printing sheet on which was printed markings indicating the type of optical disk, additional information relating to the optical disk, decorative images and so forth.

(Fabrication of Substrate Sheet)

Polyethylene was molten extrusion coated onto both sides of a polylactic acid film drawn having a thickness of 1.0 mm (Mitsubishi Plastics, Ecoloju) after carrying out simple adhesive treatment such as corona treatment, followed by preliminarily forming a release layer having a thickness of 0.015 mm.

(Fabrication of Recording Layer Sheet)

Surface irregularities corresponding to tracks and information pits were transferred to a copper-plated roll after which the roll was chrome-plated from above to obtain a transfer mold.

An ultraviolet-cured resin was coated onto a high-density polyethylene film drawn to a thickness of 0.05 mm with a die coater to a thickness of 0.1 mm, and the transfer mold was pressed against its surface to transfer the surface irregularities to the surface of the ultraviolet-cured resin.

Next, the ultraviolet-cured resin was irradiated with ultraviolet light to cure the ultraviolet-cured resin and form tracks.

Next, aluminum was vacuum deposited on the tracks and a light reflecting layer having a thickness of 60 nm was formed to obtain a playback-only type of recording layer sheet.

(Lamination)

An acrylic pressure-sensitive adhesive was coated onto the printed surface of the printing sheet to a thickness of 0.005 mm by microgravure coating after which it was laminated with the substrate sheet.

Next, an acrylic pressure-sensitive adhesive was coated on the recording layer sheet to a thickness of 0.005 mm by microgravure coating after which it was laminated onto the other side of the substrate sheet to which the printing sheet had been laminated.

Next, an acrylic pressure-sensitive adhesive was coated onto a protective sheet (high-density polyethylene film drawn to a thickness of 0.065 mm) to a thickness of 0.005 mm by microgravure coating after which it was laminated onto recording layer on the substrate sheet to obtain an optical disk roll.

(Punching)

Next, the optical disk roll was punched into the shape of disks using a disk-shaped cutting blade to obtain optical disks. The optical disks were subsequently placed between flat plates followed by the application of heat at 50° for 24 hours to remove any warping and obtain smooth optical disks.

(Evaluation)

When information recorded on the resulting optical disks was read using an optical disk drive manufactured by Pulstec Industrial Co., Ltd. (product name: DDU-1000), the information was able to be read without problem.

In addition, the substrate (+release layer), recording layer (+pressure-sensitive adhesive layer+protective layer) and printing layer (+pressure-sensitive adhesive layer) were able to be separated, and the substrate and printing layer were able to be disposed of by burying underground. The protective layer was able to be further separated from the recording layer (+pressure-sensitive adhesive layer+protective layer), and the protective layer was able to be disposed of by burying underground. The metal thin film component was recovered from the recording layer.

### Example 2

With the exception of changing the fabrication of the recording layer sheet as described below, optical disks were obtained in the same manner as Example 1.

(Fabrication of Recording Layer Sheet)

Surface irregularities corresponding to tracks and information pits were transferred to a copper-plated roll after which the roll was chrome-plated from above to obtain a transfer mold.

An ultraviolet-cured resin was coated onto a high-density polyethylene film drawn to a thickness of 0.05 mm with a die coater to a thickness of 0.1 mm, and the transfer mold was pressed against its surface to transfer the surface irregularities to the surface of the ultraviolet-cured resin.

Next, the ultraviolet-cured resin was irradiated with ultraviolet light to cure the ultraviolet-cured resin and form tracks.

Next, aluminum was vacuum deposited on the tracks and a light reflecting layer having a thickness of 60 nm was formed.

Next, a cyanine pigment was coated onto the light reflecting layer by microgravure coating to form a colored film having a thickness of 60 nm and obtain a write-once type of recording layer sheet.

(Evaluation)

When information was recorded (writing) and information recorded on the resulting optical disks was read using an optical disk drive manufactured by Pulstec Industrial Co., Ltd. (product name: DDU-1000), the information was able to be recorded and read without problem.

In addition, the substrate (+release layer), recording layer (+pressure-sensitive adhesive layer+protective layer) and printing layer (+pressure-sensitive adhesive layer) were able to be separated, and the substrate and printing layer were able to be disposed of by burying underground. The protective layer was able to be further separated from the recording layer (+pressure-sensitive adhesive layer+protective layer), and the protective layer was able to be disposed of by burying underground. The metal thin film component was recovered from the recording layer.

### Example 3

With the exception of changing the fabrication of the recording layer sheet as described below, optical disks were obtained in the same manner as Example 1.

(Fabrication of Recording Layer Sheet)

Surface irregularities corresponding to tracks were transferred to a copper-plated roll after which the roll was chrome-plated from above to obtain a transfer mold.

An ultraviolet-cured resin was coated onto a high-density polyethylene film drawn to a thickness of 0.05 mm with a die coater to a thickness of 0.1 mm, and the transfer mold was pressed against its surface to transfer the surface irregularities to the surface of the ultraviolet-cured resin.

Next, the ultraviolet-cured resin was irradiated with ultraviolet light to cure the ultraviolet-cured resin and form tracks.

Next, aluminum was vacuum deposited on the tracks and a light reflecting layer having a thickness of 60 nm was formed.

Next, an SiO₂ film having a thickness of 220 nm, a GeSbTe film having a thickness of 13 nm, an SiO₂ film having a thickness of 25 nm, a GeSbTe film having a thickness of 40 nm and an SiO₂ film having a thickness of 95 nm were sequentially formed by sputtering on the light reflecting layer to obtain a rewritable type of recording layer sheet.

(Evaluation)

When information was recorded (writing), information recorded on the resulting optical disks was read, the recorded information was erased and information was then rewritten using an optical disk drive manufactured by Pulstec Industrial Co., Ltd. (product name: DDU-1000), the information was able to be recorded, read, erased and rewritten without problem.

In addition, the substrate (+release layer), recording layer (+pressure-sensitive adhesive layer+protective layer) and printing layer (+pressure-sensitive adhesive layer) were able to be separated, and the substrate and printing layer were able to be disposed of by burying underground. The protective layer was able to be further separated from the recording layer (+pressure-sensitive adhesive layer+protective layer), and the protective layer was able to be disposed of by burying underground. The metal thin film component was recovered from the recording layer.

### Example 4

With the exception of molten extrusion coating polyethylene onto both sides of a high-density polyethylene film drawn to a thickness of 1.0 mm for the substrate sheet, and forming in advance a release layer having a thickness of 0.015 mm, optical disks were obtained in the same manner as Example 1.

(Evaluation)

When information recorded on the resulting optical disks was read using an optical disk drive manufactured by Pulstec Industrial Co., Ltd. (product name: DDU-1000), the information was able to be read without problem.

In addition, the substrate (+release layer), recording layer (+pressure-sensitive adhesive layer+protective layer) and printing layer (+pressure-sensitive adhesive layer) were able to be separated, and the substrate and printing layer were able to be disposed of by burying underground. The protective layer was able to be further separated from the recording layer (+pressure-sensitive adhesive layer+protective layer), and the protective layer was able to be disposed of by burying underground. The metal thin film component was recovered from the recording layer.

### INDUSTRIAL APPLICABILITY

An optical disk of the present invention, in which a substrate composed of a biodegradable resin or polyolefin resin is used for the substrate, is both environmentally friendly and inexpensive.

1. An optical disk comprising:
a substrate including a biodegradable resin or polyolefin resin; and
a recording layer provided on both sides of the substrate;
wherein the recording layer has a base material layer included a non-hydrophilic film.

2. An optical disk comprising:
a substrate including a biodegradable resin or polyolefin resin;
a recording layer provided on one side of the substrate; and
a printing layer provided on the opposite side of the side of the substrate on which the recording layer is provided;
wherein the recording layer and the printing layer have a base material layer included a non-hydrophilic film.

3. An optical disk according to claim 1, further comprising:
a protective layer for protecting the recording layer.

4. An optical disk according to claim 2, further comprising:
a protective layer for protecting the recording layer.

5. An optical disk according to any of claims 1 through 4, further comprising:
a release layer provided between the substrate and the recording layer.

6. An optical disk according to claim 2, further comprising:
a release layer provided between the substrate and the printing layer.

7. A manufacturing method of an optical disk comprising the steps of:
a recording layer sheet fabrication step in which a recording layer sheet is fabricated by forming tracks on a recording layer base material included a non-hydrophilic film; and
a recording layer sheet lamination step in which a recording layer included the recording layer sheet is provided on both sides of a substrate included a biodegradable resin or polyolefin resin by laminating the recording layer sheet with a substrate sheet included a biodegradable resin or polyolefin resin.

8. A manufacturing method of an optical disk comprising the steps of:
a recording layer sheet fabrication step in which a recording layer sheet is fabricated by forming tracks on a recording layer base material included a non-hydrophilic film;
a printing sheet fabrication step in which a printing sheet is fabricated by carrying out printing on a printing base material included a non-hydrophilic film;
a recording layer sheet lamination step in which a recording layer included the recording layer sheet is provided on a substrate included a biodegradable resin or polyolefin resin by laminating the recording layer sheet with a substrate sheet included a biodegradable resin or polyolefin resin; and
a printing sheet lamination step in which a printing layer included the printing sheet is provided on a substrate included a biodegradable resin or polyolefin resin by laminating the printing sheet with a substrate sheet included a biodegradable resin or polyolefin resin.

9. A manufacturing method of an optical disk according to claim 7, further comprising the steps of:
a protective film lamination step is possessed in which a protective layer included a protective film is provided on the recording layer by laminating the protective film onto the recording layer.

10. A manufacturing method of an optical disk according to claim 8, further comprising the steps of:
a protective film lamination step is possessed in which a protective layer included a protective film is provided on the recording layer by laminating the protective film onto the recording layer.

11. A manufacturing method of an optical disk according to any of claims 7 through 10, further comprising the steps of:
a release layer formation step is possessed in which a release layer is formed on at least one side of the substrate sheet in advance.

12. A manufacturing method of an optical disk according to any of claims 7 through 10, wherein each sheet is produced in the form of a wound roll, and each of these sheets is laminated in the form of wound rolls.

13. A manufacturing method of an optical disk according to claim 8, wherein the printing sheet fabrication step has a step in which mutually different variable information imparted to each optical disk produced is printed on the printing base material.
